(19) United States
(12) Patent Application Publication
(10) Pub. No.: US 2005/0247796 A1
(43) Pub. Date: Nov. 10, 2005

(54) Memory-card type USB mass storage device

(76) Inventor: I. Ming Chen, Taipei City (TW)

Correspondence Address: Bruce H. Troxell;Troxell Law Office PLLC, Suite 1404, 5205 Leesburg Pike, Falls Church, VA, 22041, US

(21) Appl. No.: 10/838,355

(22) Filed: May 5, 2004

(51) Int. Cl. G06K 19/06; G06K 7/00

(52) U.S. Cl. 235/492; 235/486

(57) ABSTRACT

A compact and portable memory-card type USB mass storage device includes at least a circuit board and an electric connector. A plurality of elastic leaf-like terminals corresponding to contacts on a specific matching memory card, such as SD, MS, MMC or SMC, that is to be engaged with the circuit board, and other necessary electronic elements are directly mounted on a surface of the circuit board. The electric connector is provided at an end of the circuit board for freely plugging onto a computer or other electronic apparatus. A case protectively encloses the circuit board and the electric connector, and is provided at an end with a memory card slot, via which the memory card is inserted into the case, and at an opposite end with an opening for the electric connector to expose therefrom for connecting to the computer and so on.

### FIELD OF THE INVENTION

The present invention relates to a memory-card type universal serial bus (USB) mass storage device, and more particularly to a portable, compact, and utility memory-card type USB mass storage device that allows a specific type of memory card to insert in and electrically connect thereto, and plug of an end thereof to an electronic apparatus, such as a computer, to perform reading and writing of data from and into the memory card inserted therein.

### BACKGROUND OF THE INVENTION

Most of the currently available electronic products are digitalized. For example, digital cameras, digital video cameras, digital television sets, electronic interpreters, game machines, printers, etc., all are very common digital products that use a memory card for storing data, such as pictures, films, texts, programs, etc. Frequently, these data must be compiled or restored via a computer. Therefore, a card reader for reading the memory card must be connected to the computer as a peripheral thereof.

Since the conventional magnetic disks have a capacity that is too small to enable transfer of mass data between two or more computers, various types of high-capacity non-volatile memory cards, such as Secure Digital (SD), Memory Stick (MS), MultiMedia Card (MMC), SmartMedia Card (SMC), etc., have been developed and introduced into the market to gradually replace the conventional magnetic disks. However, most currently available personal computers do not have a card reader mounted therein. Therefore, it is impossible to read data from a memory card when it is desired to transfer the data from the memory card to one computer or to compile the memory card data on a computer without a card reader.

A conventional card reader typically includes a circuit board, to a surface of which an electric connector for one or more types of memory cards is welded. The electric connector normally includes many complicate elements, including, for example, an insulated base, connecting terminals, a metal case, and a ground plate, and is therefore difficult to manufacture and assemble, making the whole card reader big in volume and not convenient for carrying, and accordingly failed to freely connect to a computer or other electronic apparatus that does not include a card reader.

It is therefore tried by the inventor to develop a memory-card type USB mass storage device that eliminates the drawbacks existed in the conventional card readers or the electric connectors thereof, such as complicate structure, big volume, inconvenient for carrying, etc.

### SUMMARY OF THE INVENTION

A primary object of the present invention is to provide a memory-card type USB mass storage device that is small and compact for conveniently carrying along with a user for use with any computer or other electronic apparatus that does not include a card reader.

Another object of the present invention is to provide a memory-card type USB mass storage device that allows at least one memory card to insert thereinto and could then be freely plugged onto a computer or other electronic apparatus for use.

To achieve the above and other objects, the memory-card type USB mass storage device of the present invention mainly includes at least a circuit board and an electric connector. The electric connector is a universal serial bus (USB) connection port. The circuit board is directly provided on a surface thereof with a plurality of elastic leaf-like terminals corresponding to contacts on a specific matching memory card, such as SD, MS, MMC, or SMC, and other necessary electronic elements, so that the specific memory card inserted into the USB mass storage device of the present invention is electrically connected to the circuit board. The electric connector is provided at one end of the circuit board and adapted to freely plug onto a computer or other electronic apparatus.

In another embodiment of the present invention, a case is provided to protectively enclose the circuit board and the electric connector. The case is provided at an end with a memory card slot, via which a memory card is inserted to electrically connect to the circuit board, and at another opposite end with an opening allowing the electric connector to expose therefrom for freely plugging onto a computer or an electronic apparatus.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is aperspective view showing an internal structure of a memory-card type USB mass storage device according to the present invention;

FIG. 2 is a side view of FIG. 1 with a case of the USB mass storage device shown in phantom lines;

FIG. 3 is a phantom perspective view showing the memory-card type USB mass storage device of the present invention in use;

FIG. 4 is a perspective view of a case for the memory-card type USB mass storage device of the present invention;

FIG. 5 shows the case of FIG. 4 has an open end forming a memory card slot, via which a memory card is inserted into the case; and

FIG. 6 shows the case of FIG. 4 has another open end to expose an electric connector for the memory-card type USB mass storage device of the present invention.

### DETAILED DESCRIPTION OF THE PREFERRED EMBODIMENTS

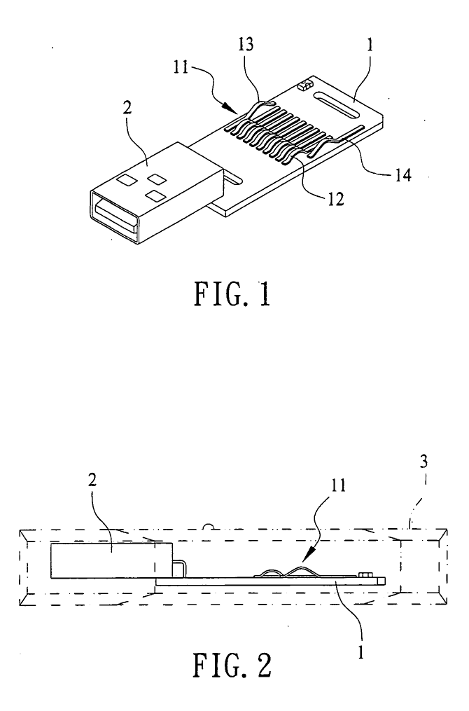

Please refer to FIGS. 1, 2, and 3, in which a memory-card type USB mass storage device according to the present invention is shown. The memory-card type USB mass storage device of the present invention has a structure adapted for conveniently carrying along with a user and includes at least a circuit board 1, an electric connector 2, and a case 3, so that a memory card 4 may be inserted into the case 3 for use.

As can be seen from FIG. 1, a plurality of elastic leaf-like terminals 11 corresponding to electric contacts on a specific matching memory card 4, such as SD, MS, MMC or SMC, and other necessary electronic elements are directly fixedly mounted or welded to a surface of the circuit board 1. The elastic leaf-like terminals 11 may include one of more types of the following terminals: read/write terminals 12 needed by the memory card 4, a signal-starting terminal 13, a write-protect terminal 14, and other terminals, such as a ground terminal and/or a dumb-protect terminal, so that the specific memory card 4 inserted into the case 3 is electrically connected to the circuit board 1 via the terminals 11.

The electric connector 2 is a removable electric connecting element adapted for freely plugging onto a computer or other electronic apparatus to enable transmission of signal data, and may be a universal serial bus (USB) connection port as shown in FIG. 1.

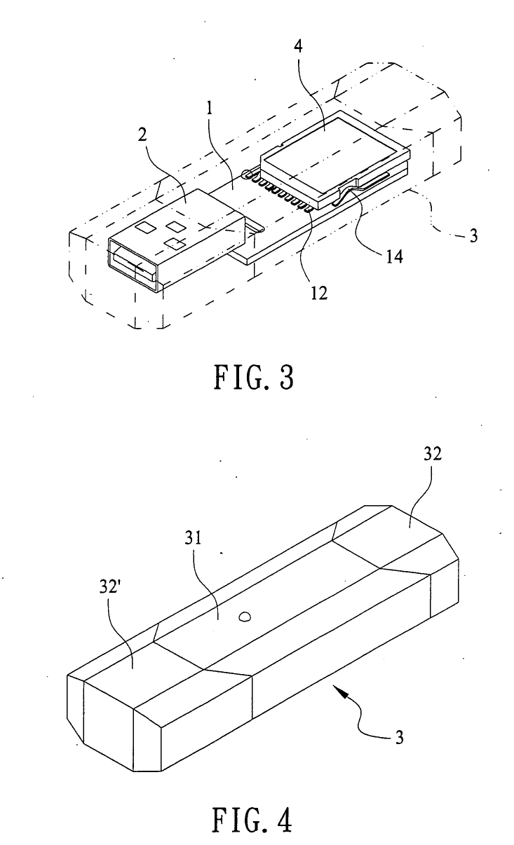

As shown in FIGS. 1 and 2, the electric connector 2 is mounted to an end of the circuit board 1 to forward project therefrom. The case 3 is provided at an outer side of the circuit board 1 and the electric connector 2 to enclose at least part of the two elements. Or alternatively, the case 3 encloses the whole circuit board 1 and the electric connector 2 but is openable to allow a user to access the circuit board 1 and/or the electric connector 2. The specific memory card 4 is inserted via an end of the circuit board 1 opposite to the electric connector 2 to electrically connect to the terminals 11, as shown in FIG. 3. The electric connector 2 is adapted to plug onto a computer or other electronic apparatus for use.

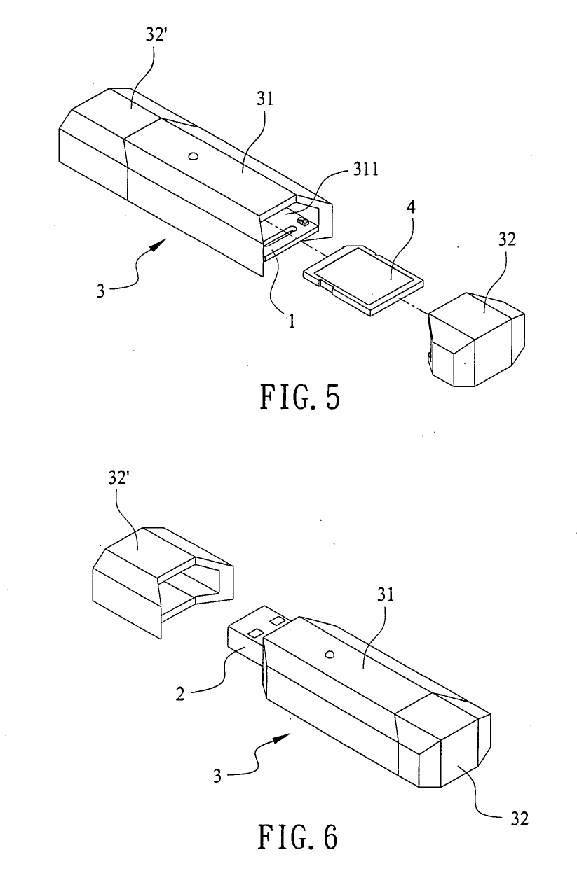

Please refer to FIGS. 4, 5, and 6. In a preferred embodiment of the present invention, the case 3 includes a main body 31, and two end caps 32, 32′ removably closed to two open ends of the main body 31. The main body 31 of the case 3 encloses the circuit board 1 and a large part of the electric connector 2. One of the two open ends of the main body 1 that is opposite to the electric connector 2 (that is the end closed with the end cap 32 in the illustrated embodiment) serves as a memory card slot 311, as shown in FIG. 5, for a matching memory card 4, such as an SD, an MS, an MMC, or an SMC, to insert into the case 3 via the memory card slot 311 to electrically contact or engage with the a plurality of elastic leaf-like terminals 11 on the circuit board 1. The other open end of the main body 31, that is the end closed with the end cap 32′ in the illustrated embodiment, partially encloses the electric connector 2, so that a front portion of the electric connector is projected therefrom, as shown in FIG. 6, for plugging onto an external electronic apparatus. The end caps 32, 32′ are selectively removably closed to the two open ends of the main body 31 for covering the memory card slot 311 and the front portion of the electric connector 2, so as to protect the circuit board 1, the electric connector 2, and the memory card 4 inserted in the main body 31.

In the memory-card type USB mass storage device of the present invention, since the elastic leaf-like terminals 11 are directly fixedly mounted on the surface of the circuit board 1, the insulated base and the metal case for the electric connector of the conventional memory card reader are omitted to enable a largely simplified structure and largely reduced volume of the memory-card type USB mass storage device of the present invention. The case 3 for the present invention can therefore have reduced dimensions to enable the present invention to be conveniently carried along with a user for use at any time by plugging onto a computer or an electronic apparatus that does not include a card reader.

1. A memory-card type USB mass storage device, comprising a circuit board, an electric connector, and a case;
said circuit board including a plurality of elastic leaf-like terminals directly fixedly mounted on a surface of said circuit board to correspond to electric contacts on a specific matching memory card to be engaged with said circuit board, and other necessary electronic elements;
said electric connector being a removable electric connecting element adapted for freely plugging onto an electronic apparatus for transmission of signal data; said electric connector being mounted to an end of said circuit board to forward project therefrom; and
said case being provided at an outer side of said circuit board and said electric connector to enclose said circuit board and at least a large part of said electric connector;
whereby a matching memory card could be inserted into said case to electrically contact with said elastic leaf-like terminals on said circuit board.

2. The memory-card type USB mass storage device as claimed in claim 1, wherein said elastic leaf-like terminals include one or more types of the following terminals: read/write terminals needed by said matching memory card, a signal starting terminal, a write-protect terminal, and other terminals.

3. The memory-card type USB mass storage device as claimed in claim 1, wherein said electric connector comprises a universal serial bus (USB) connection port.

4. The memory-card type USB mass storage device as claimed in claim 1, wherein said case includes a main body having two open ends, one of said two open ends forming a memory card slot, via which said matching memory card is inserted into said case.

5. The memory-card type USB mass storage device as claimed in claim 1, wherein said case includes a main body having two open ends, one of said two open ends corresponding to said electric connector allows a front portion of said electric connector to project therefrom.

6. The memory-card type USB mass storage device as claimed in claim 4, wherein said case includes an end cap for removably closing said memory card slot.

7. The memory-card type USB mass storage device as claimed in claim 5, wherein said case includes an end cap for removably covering said front portion of said electric connector.
